(19) United States
(12) Patent Application Publication
(10) Pub. No.: US 2026/0211587 A1
(43) Pub. Date: Jul. 23, 2026

(54) INDUSTRIAL PRINTING SYSTEM, MANAGEMENT SERVER, AND MANAGEMENT METHOD FOR PERFORMING A SIMULATION TO IMPROVE UTILIZATION RATE, PRODUCTIVITY, AND RELIABILITY

(71) Applicant: KYOCERA Document Solutions Inc., Osaka (JP)

(72) Inventor: Taku MATSUO, Los Angeles, CA (US)

(73) Assignee: KYOCERA Document Solutions Inc., Osaka (JP)

(21) Appl. No.: 19/026,473

(22) Filed: Jan. 17, 2025

(51) Int. Cl. G06F 3/12

(52) U.S. Cl. CPC G06F 3/1203; G06F 3/1229; G06F 3/1282

(57) ABSTRACT

Provided is an industrial printing system that enables the comparison of a utilization rate, productivity, and reliability among component apparatuses. An information acquisition unit acquires one or any combination of utilization rate information, productivity information, and reliability information from a plurality of component apparatuses. An analysis unit generates analysis information that compares and analyzes the utilization rate information, productivity information, and reliability information acquired by the information acquisition unit. The simulation unit simulates one or any combination of the utilization rate, productivity, and reliability, based on the analysis information generated by the analysis unit in accordance with the designation information that designates one of the plurality of component apparatuses.

### BACKGROUND

The present disclosure relates to an industrial printing system, management server, and processing management method, particularly for industrial printing (production printing).

In industrial printing, also known as production printing, which uses commercial (industrial) printing apparatus, the components of the final product are produced in separate processes. For example, in the case of bookbinding, the cover, main body (color), main body (black and white), promotional materials, bands, and shipping envelopes are each processed as a separate job. Then, while combining each job in the middle of the process, the final product is finished as a book.

On the other hand, as a typical technology, an apparatus management system that provides a server and a terminal apparatus with a display is disclosed. In this technology, the server receives the first operational information from the apparatus to be managed. The terminal apparatus displays the first screen information on the display unit based on the first operating information, and it makes a request to the server to acquire information in response to the operation based on the first screen information. The server requests the apparatus to provide the second operating information based on the request from the terminal apparatus, and it receives the second operating information transmitted by the apparatus in response to the request. The terminal apparatus displays the second screen information based on the second operating information received by the server on the display unit.

### SUMMARY

An industrial printing system according to the present disclosure is an industrial printing system for production printing, having a plurality of component apparatuses and a management server that manages the plurality of component apparatuses, the management server including: an information acquisition unit that acquires one or any combination of utilization rate information, productivity information, and reliability information from the plurality of component apparatuses; an analysis unit that generates analysis information by comparing and analyzing the utilization rate information, productivity information, and reliability information acquired by the information acquisition unit; and a simulation unit that simulate one or any combination of utilization rate, productivity, and reliability based on the analysis information generated by the analysis unit in accordance with designation information that designates any one of the plurality of component apparatuses.

A management server according to the present disclosure is a management server that manages a plurality of component apparatuses in an industrial printing system that performs production printing, including: an information acquisition unit that acquires one or any combination of utilization rate information, productivity information, and reliability information from the plurality of component apparatuses; an analysis unit that generates analysis information by comparing and analyzing the utilization rate information, productivity information, and reliability information acquired by the information acquisition unit; and a simulation unit that simulates one or any combination of utilization rate, productivity, and reliability based on the analysis information generated by the analysis unit in accordance with designation information that designates one of the plurality of component apparatuses.

A management method according to the present disclosure is a management method for managing a plurality of component apparatuses by an industrial printing system that performs production printing, including the steps of: acquiring from the plurality of component apparatuses one or any combination of utilization rate information, productivity information, and reliability information; generating analysis information by comparing and analyzing the acquired utilization rate information, productivity information, and reliability information; and simulating one or any combination of utilization rate, productivity, and reliability based on the generated analysis information in accordance with the designation information that designates any one of the plurality of component apparatuses.

### BRIEF DESCRIPTION OF THE DRAWINGS

FIG. 1 is an example of a system configuration diagram of an industrial printing system according to the embodiment of the present disclosure;

FIG. 2 is a block diagram showing the control configuration of the management server as shown in FIG. 1;

FIG. 3 is a block diagram showing the functional configuration of the management server as shown in FIG. 1;

FIG. 4 is a block diagram showing details of the acquisition information as shown in FIG. 3;

FIG. 5 is a flowchart of the dashboard process according to the embodiment of the present disclosure; and

FIG. 6 is an example of the drawing of the dashboard as shown in FIG. 5.

### DETAILED DESCRIPTION

### Embodiment

### Configuration of Industrial Printing System X

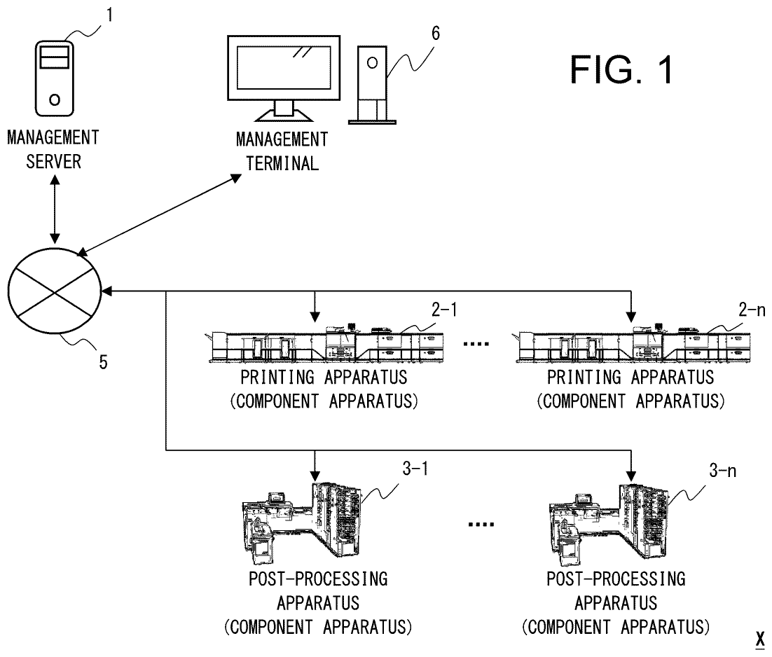

Firstly, as refer to FIG. 1, an example of the overall system configuration of the industrial printing system X according to the present embodiment is described.

The industrial printing system X according to the present embodiment is a system that manages the workflow of output from the printing process and post-processing process (hereinafter, they are also simply referred to as “printing”) in industrial printing (production printing).

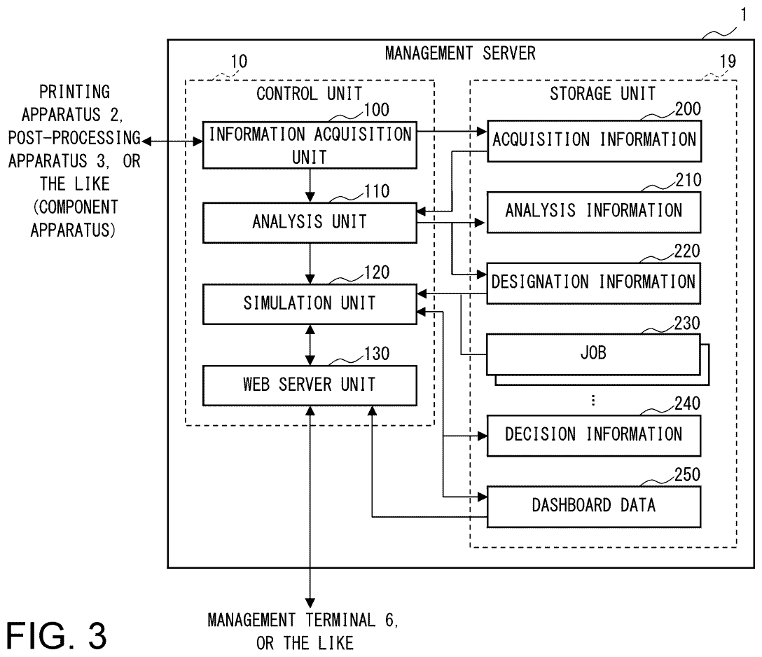

In the present embodiment, the industrial printing system X regards the final output of books, or the like, as an “order,” and each component of the order is a job 230 (FIG. 3).

In the present embodiment, the industrial printing system X provides a management server 1 that manages apparatuses installed at locations such as printing companies and printing factories, including group companies, dealers, manufacturers, or the like. Specifically, the industrial printing system X manages printing-related apparatuses (hereinafter referred to as “component apparatuses,”) including printing apparatuses 2-1 to 2-n and post-processing apparatuses 3-1 to 3-n, and it collects and analyzes information from these. Further, in the industrial printing system X, a management terminal 6 used by a user such as an administrator is connected to the management server 1 via a network 5.

Hereinafter, when referring to one of the printing apparatuses 2-1 to 2-n, it is simply referred to as the printing apparatus 2. Similarly, when referring to one of the post-processing apparatuses 3-1 to 3-n, it is simply referred to as the post-processing apparatus 3.

The management server 1 is an information processing apparatus that manages and controls the component apparatuses provided. The management server 1 is configured with a personal computer (PC,) server, dedicated machine, general-purpose machine, or the like.

In the present embodiment, the management server 1 may be a server for a “fleet” on the so-called cloud.

Further, the management server 1 may be provided with a function of a print controller or a digital front end (DFE) that assigns the processing of a job 230 to each component apparatus in the relevant location and executes the processing according to the schedule.

In the present embodiment, the management server 1 executes dedicated management (order output management) application software (hereinafter simply referred to as “application”), manages the job 230 (FIG. 3) and a plurality of component apparatuses, collects information, and performs comparative analysis. This management application (hereinafter referred to as the “dedicated application”) may be executed on a common platform. On this common platform, printing design creation, user management, tenant management, security management, notification services for maintenance, prepress processing management, storage management for each document, and management of component apparatuses may be executed.

In addition, in the present embodiment, the management server 1 sends and receives various instructions and information with the printing apparatus 2 and post-processing apparatus 3 in production printing. This enables the management server 1 to manage the status of each apparatus and request processing of the job 230.

** The printing apparatus 2 is an industrial printer including image forming apparatus, an automated offset printing apparatus, a digital printer, and a multi-functional peripheral (MFP), or the like. The printing apparatus 2 is capable of performing printing processes such as small-lot printing or mass (multi-lot) offset printing.

Each of the printing apparatus 2 according to this embodiment may differ in the size, paper quality, color profile, recordable range, and the like, of the recording paper used in the printing process.

The post-processing apparatus 3 is an apparatus that can perform post-processing (post-treatment) of the printed paper, such as folding, collating, binding, trimming, bookbinding, and the like.

The post-processing apparatus 3 at each location in the present embodiment may also differ in the content and range of the processing that can be performed in the post-processing process.

The network 5 includes the Internet, other wide area network (WAN), other dedicated line, a mobile phone network, local area network (LAN), wireless LAN (Wi-Fi), industrial networks, voice telephone networks, or the like. The network 5 is capable of sending and receiving various commands and data with each apparatus. Furthermore, the management server 1 and each component apparatus may also be connected via a LAN or other intranet within the network 5. In addition, the network 5 may also be configured as a virtual private network (VPN).

The management terminal 6 is an information processing apparatus such as a PC, smartphone, tablet terminal, personal data assistant (PDA), dedicated terminal, or the like. The management terminal 6 is used by a user such as an administrator to control printing, and the like. In the present embodiment, the management terminal 6 executes a dedicated application to access the management server 1. This allows the user to comparatively view information on the target component apparatus and the “own component apparatus” to be compared, set and instruct a simulation, check costs, or the like.

In addition, the management terminal 6 can also execute applications that control the design and prepress of production printing. Furthermore, the management terminal 6 may be connected to other terminals for submitting data, design proofing terminals, or the like, for design and prepress. Furthermore, the management terminal 6 may have the function of a management apparatus that creates the job 230 and manages the processing requests for each apparatus by the management server 1. This makes it possible to acquire a job 230, design the print, submit the document, manage prepress processing, check the progress, request processing, or the like.

Note that a plurality of these apparatuses may be present depending on the purpose, scale of printing, and the like. Also, other component apparatuses managed by the management server 1 may be provided. These other component apparatuses include, for example, a terminal for submitting a document for printing, a terminal for design proofing, prepress apparatuses, or the like.

Also, in addition to the management server 1, there may also be a shipping management server that manages shipping of submitted orders after printing or post-processing is completed, and a server of an upstream system of the management server 1. Furthermore, in addition to this, another general terminal used by the user may be connected with the network 5 inside and outside each location. This general terminal may include a so-called console.

As a result, the management server 1 can be accessed by a user by using a management terminal 6 or general terminal, or the like, with a web browser, terminal, dedicated application, or the like. Therefore, the user can obtain the job 230, design printing, submit work, manage prepress processing, check progress, request processing, or the like.

### Control Configuration of Management Server 1

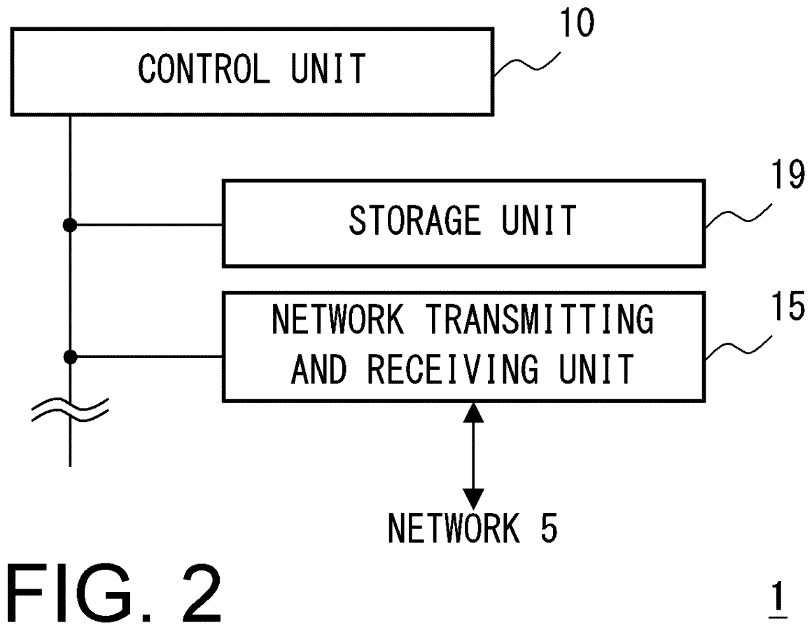

Then, as refer to FIG. 2, the control configuration of the management server 1 is explained.

The management server 1 includes a control unit 10, a network transmitting and receiving unit 15, a storage unit 19, and the like. Each unit is connected with the control unit 10 and is controlled by the control unit 10.

The control unit 10 is an information processing unit such as a general purpose processor (GPP), a central processing unit (CPU), a micro processing unit (MPU), a digital signal processor (DSP), a graphics processing unit (GPU), a neural processing unit (NPU), or an application specific integrated circuit (ASIC), an application-specific processors, or the like.

The control unit 10 reads out the control program stored in the ROM or HDD in the storage unit 19, and by expanding this control program in the RAM and executing it, thus, it can be made to operate as each part of the functional block as described later. In addition, the control unit 10 controls the entire apparatus in response to the instruction information input from the management terminal 6, general terminal, or the like.

The network transmitting and receiving unit 15 is a network connection unit that includes a LAN board and wireless transmitting and receiving unit for connecting with the network 5.

The network transmitting and receiving unit 15 transmits and receives data over data communication lines and transmits and receives voice signals over voice telephone lines.

The storage unit 19 is a non-transitory recording medium. The storage unit 19 includes semiconductor memory such as read only memory (ROM) and random access memory (RAM), magnetic storage such as hard disk drive (HDD), or the like.

The ROM and HDD in storage unit 19 store the control program for controlling the operation of management server 1. This control program includes the operating system (OS), middleware on the OS, services (daemons), various applications, database data, or the like. Among these, the various applications include the dedicated application as described above.

In the present embodiment, the storage unit 19 may store programs and data for processing raster-in-process (hereinafter abbreviated as “rasterize” or “RIP,”) which converts vector (line drawing) image data into image data (raster data) for printing. The programs and data for this rasterize processing include commercial libraries and fonts, or the like. In addition, the storage unit 19 also stores information on connected component apparatuses, control programs, or the like.

Furthermore, the storage unit 19 may also store user account settings and other data for the industrial printing system X.

In addition, in the management server 1, the control unit 10 may be integrally formed, such as a CPU with a GPU, a chip-on-module package, a system on a chip (SOC), or the like.

The control unit 10 may also be built-in with RAM, ROM, flash memory, or the like.

### Functional Configuration of Management Server 1

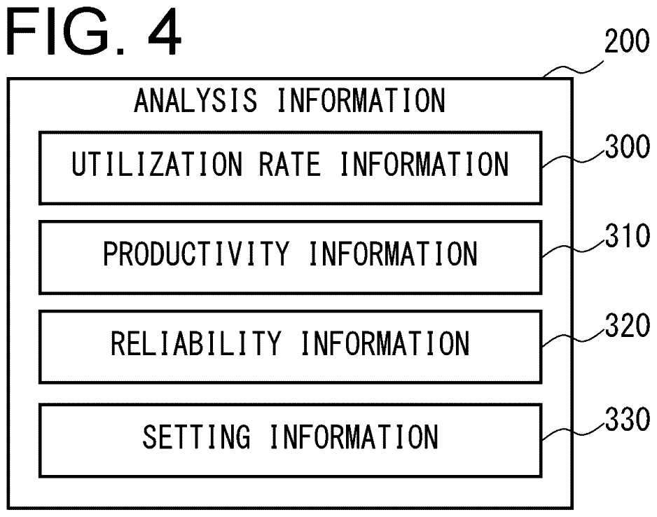

Here, as refer to FIGS. 3 and 4, a functional configuration of the management server 1 is described.

The control unit 10 of the management server 1 provides with an information acquisition unit 100, an analysis unit 110, a simulation unit 120, and a web server unit 130.

The storage unit 19 stores acquisition information 200, analysis information 210, designation information 220, job 230, decision information 240, and dashboard data 250.

The information acquisition unit 100 acquires either or any combination of utilization rate information 300, the productivity information 310, and the reliability information 320 from a plurality of component apparatuses.

Furthermore, the information acquisition unit 100 may also acquire setting information 330 for the plurality of component apparatuses.

The analysis unit 110 generates the analysis information 210 by comparing and analyzing the utilization rate information 300, the productivity information 310, and the reliability information 320 acquired by the information acquisition unit 100.

In the present embodiment, the analysis unit 110 may detect a target component apparatus with relatively high operational performance by comparing the analysis information 210 between a plurality of component apparatuses and set it to the designation information 220.

The simulation unit 120 simulates the operation rate, productivity, and reliability, or any combination thereof, based on the analysis information 210 generated by the analysis unit 110, in accordance with the designation information 220 that specifies one of the plurality of component apparatuses.

Here, the simulation unit 120 may simulate the processing in the target component apparatus based on the designation information 220.

Further, the simulation unit 120 can also output the decision information 240 for operational improvement and the acquisition of the next component apparatus through simulation.

Furthermore, the simulation unit 120 can also perform simulation for the past jobs 230 for a specific period of time based on the setting information 330 or in case that the setting information 330 is changed.

The web server unit 130 presents the results of the simulation of its own component apparatus regarding the target component apparatus, or the like, to the management terminal 6 as a dashboard. The web server unit 130 may make it possible to access the dashboard from the web server or dedicated application of the management terminal 6 by executing the server and service (Daemon) of the World Wide Web (WWW). The web server unit 130 may also provide web services such as user authentication.

The acquisition information 200 is information acquired from each component apparatus for comparison and simulation.

Details of the acquisition information 200 are described later.

The analysis information 210 is information that shows the results of the comparative analysis of the acquisition information 200. The analysis information 210 may be, for example, data written in JavaScript Object Notation

(JSON) format or a database file by Extensible Markup Language (XML).

The designation information 220 is information for designating a target component apparatus. In the present embodiment, “the target component apparatus” is any one of a plurality of component apparatuses and is the subject of comparison results and simulations on the dashboard. In the designation information 220, a component apparatus that has been detected as having a relatively high operational performance through comparison with the analysis information 210 may be designated as the target component apparatus. In this case, the target component apparatus can be specified by ID (Identification), model type, or the like. Alternatively, in the designation information 220, the target component apparatus may be designated by the user via the dedicated application, or the like, or based on the results of the simulation.

The job 230 is data that summarizes various data used during printing in production printing. In the present embodiment, a plurality of jobs 230 may be stored in the storage unit 19, and any one of them or any combination of them is simply referred to as the job 230. The job 230 may be described, for example, in JDF (Job Description Format) and/or JMF (Job Messaging Format). The job 230 may include, for example, attributes specified in the printing process, a job ticket, printing data, and printing resources, RIP data, or the like.

In the present embodiment, a plurality of the job 230 are successively stored in the storage unit 19, executed, and then deleted after execution. However, for the purpose of simulation and comparison, it is possible to store data of the job 230 processed in the past (specific period) for several months to several years (hereinafter referred to as “the past job 230”) as history information.

The decision information 240 is information indicating the results of simulation for the target component apparatus. The decision information 240 may be information indicating a decision for operational improvement and acquisition of the next component apparatus. The decision information 240 may also be described in JSON or XML format.

The dashboard data 250 is data for the dashboard that shows the results of the simulation, which includes the decision information 240 for the specified component apparatus. In the present embodiment, the dashboard data 250 may be, for example, a file of images or text that can be described by using a dedicated application, or the like.

Then, as refer to FIG. 4, the details of the acquisition information 200 are explained.

The acquisition information 200 includes the utilization rate information 300, the productivity information 310, the reliability information 320, and the setting information 330.

The utilization rate information 300 is data for calculating the operation rate (utilization rate) of the component apparatus. Specifically, the utilization rate information 300 includes various status information and operation information of the component apparatus. The status information is data that indicates the status of each part and includes information such as the number of uses, self-diagnosis results, other conditions, and the like. The operating information includes information such as operating time, operating frequency, number of uses, and the like.

The productivity information 310 is data for calculating productivity of the component apparatus. The productivity information 310 includes, for example, processing job information, information related to average monthly print volume (AMPV) and overall equipment effectiveness (OEE), cost information, or the like. Among these, the cost information includes information such as the consumed amount and the cost of ink, paper, post-processing materials, or the like, the amount spent, the amount of time they occupy, the amount of electricity consumed, or the like. The cost information may also include information such as the waste rate and paper loss rate for printed materials.

The reliability information 320 is data for calculating mean time between failure (MTBF) and mean time to failure (MTTR), which indicate the reliability of the component apparatus. The reliability information 320 includes, for example, historical information such as failure replacement information, downtime information, maintenance information, and the like. Furthermore, the reliability information 320 may include information on color variation status for color management.

The setting information 330 is data that indicates the settings of the plurality of component apparatuses. For example, the setting information 330 includes settings such as color profiles, ink usage (density) and restrictions, scheduling intervals and operation settings for the job 230, batch processing conditions, maintenance schedules, schedules for color management changes and settings, or the like.

Further, the setting information 320 330 may be data that includes not only the current setting information 320 but also the past setting information 330 stored in the processing history of past the job 230.

Here, the control unit 10 of the management server 1 is made to function as the information acquisition unit 100, the analysis unit 110, the simulation unit 120, and the web server unit 130 by executing the control program stored in the storage unit 19.

In addition, the above-mentioned parts of the management server 1 are hardware resources that execute the image formation method according to the present disclosure.

Furthermore, some or any combination of the above-mentioned functional components may be configured in hardware or circuitry by using ICs, programmable logic, FPGAs (Field-Programmable Gate Arrays), or the like.

### Dashboard Process in Industrial Printing System X

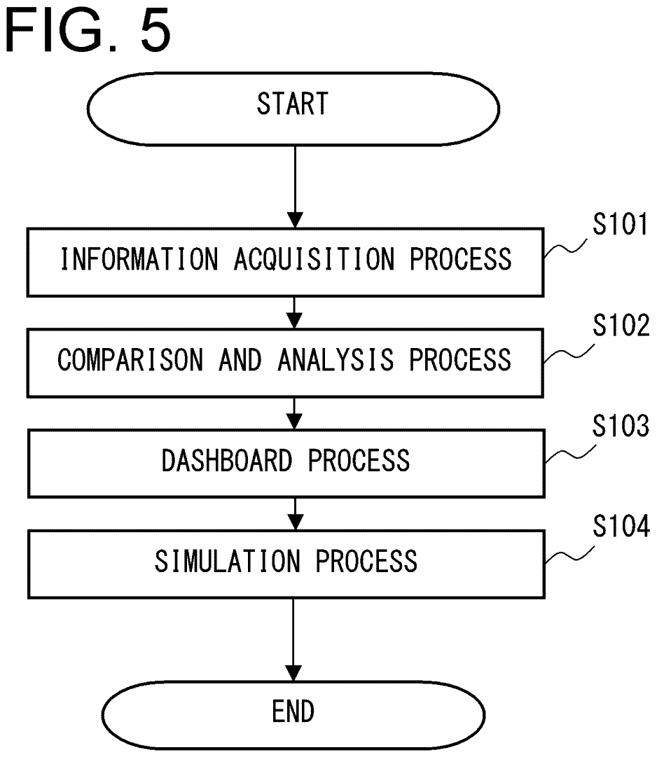

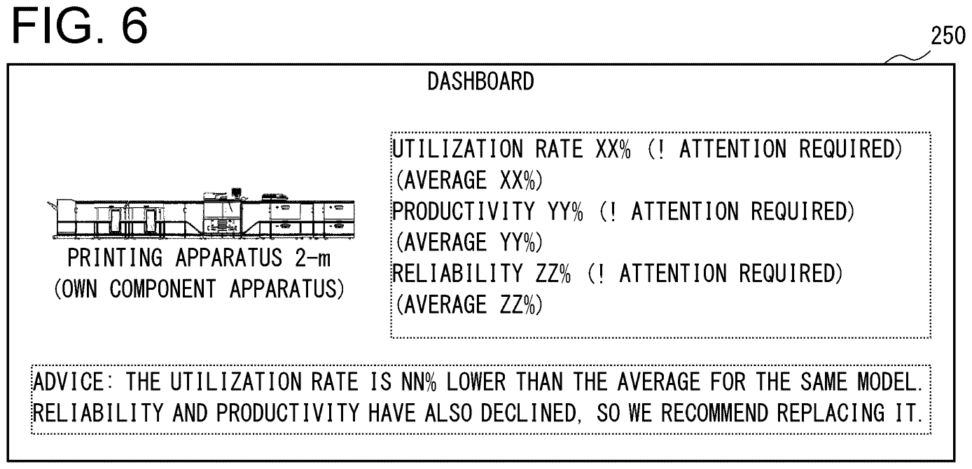

Then, as refer to FIGS. 5 and 6, the dashboard process in the industrial printing system X according to the present embodiment is described.

In the dashboard process according to the present embodiment, either or any combination of the utilization rate information 300, the productivity information 310, and the reliability information 320 is acquired from the plurality of component apparatuses. Then, the analysis information 210, which is obtained by comparing and analyzing the acquired utilization rate information 300, the productivity information 310, and the reliability information 320, is generated. This analysis information 210 is presented to the user as a dashboard drawn by using the dashboard data 250. Then, based on the generated analysis information 210, the simulation is performed for the specified own component apparatus on the dashboard, for any or any combination of the utilization rate, productivity, and reliability, in accordance with the designation information 220 that specifies any of the plurality of component apparatuses.

The dashboard process of the present embodiment is mainly performed by the control unit 10 of the management server 1, which executes the program stored in the storage unit 19 in cooperation with each unit using hardware resources.

With referring to the flowchart in FIG. 5, the details of the dashboard process according to the present embodiment are explained below in steps.

### Step S101

Firstly, the information acquisition unit 100 performs an information acquisition process.

In the present embodiment, the management server 1 is capable of managing a fleet of component apparatuses. For this reason, the information acquisition unit 100 of the management server 1 acquires acquisition information 200 from the plurality of component apparatuses it manages.

In the present embodiment, the acquisition information 200 may include any or any combination of the utilization rate information 300, the productivity information 310, the reliability information 320, and setting information 330.

### Step S102

Then, the analysis unit 110 performs a comparison and analysis process.

The analysis unit 110 compares and analyzes any or any combination of the utilization rate information 300, the productivity information 310, and the reliability information 320 in the acquisition information 200 and generates the analysis information 210.

In this process, firstly, the analysis unit 110 analyzes the utilization rate information 300, the productivity information 310, and the reliability information 320 for component apparatuses having similar page per minutes (PPM), processing speed, or duty cycle, and it stores the analysis result to the analysis information 210. For example, the analysis unit 110 may generate frequency distribution data for the utilization rate information 300, the productivity information 310, and the reliability information 320, and it may calculate the standard deviation for each component apparatus, or may perform statistical testing, other statistical analysis, comparisons by using AI (Artificial Intelligence), or heuristics (hereinafter simply referred to as “AI, or the like”).

The analysis unit 110 may also compare the information by converting it to processing speed or duty cycle for models other than the same component apparatus. In other words, it is also possible to compare different printing speeds and duty cycles.

On this basis, the analysis unit 110 searches for the target component apparatus to be a comparison target or view target among the plurality of component apparatuses.

In the present embodiment, the analysis unit 110 is able to specify the target type such as utilization rate, productivity, and reliability from the analysis information 210, and it detect the component apparatus that is being operated at a level higher than the target. Specifically, the analysis unit 110 is able to detect the component apparatus with relatively high operating performance by comparing the analysis information 210 between the plurality of component apparatuses, and it sets this apparatus as the target component apparatus in the designation information 220. Alternatively, the analysis unit 110 can set a statistically average or typical component apparatus as the target component apparatus in the designation information 220.

Alternatively, the analysis unit 110 can also search for the target component apparatus by specifying a condition via the web browser or the dedicated application from the management terminal 6, as shown later. As this condition, it is possible to specify specification information such as the model and capability information of the component apparatus, or to specify and identify the component apparatus by a specific ID. In this case, the analysis unit 110 also sets the specified target component apparatus to the designation information 220.

Then, the analysis unit 110 acquires the setting information 330 from the target component apparatus. Thus, the analysis unit 110 compares the utilization rate, productivity, and reliability between the target component apparatus and other component apparatuses.

Specifically, for example, when comparing utilization rates, the analysis unit 110 converts and compares data not only between component apparatuses with the same processing speed (PPM) and duty cycle, but also between components with different processing speeds and duty cycles. For example, when the analysis unit 110 compares component apparatuses with 120 PPM and 150 PPM, it converts the utilization rate information 300 for 150 PPM to 80% and compares the data.

As a comparison of productivity, the analysis unit 110 calculates and compares information on printing costs based on the consumption of ink and paper, costs, usage amounts, occupied time, power consumption, or the like. In addition, the analysis unit 110 can also compare the waste rate and paper loss rate based on information on the waste rate and paper loss rate for printed materials.

As a comparison of reliability, the analysis unit 110 compares MTBF, MTTR, or the like, based on failure replacement information, downtime information, and maintenance information from the history information of the component apparatus. Furthermore, the analysis unit 110 can also compare color reproduction rates based on color fluctuation status in color management.

The analysis unit 110 stores the results of these comparisons in the analysis information 210.

### Step S103

Then, the web server unit 130 performs a dashboard process.

The web server unit 130 accepts access from the user's web browser or dedicated application from the management terminal 6, or the like.

Here, the user can select the level of information they wish to receive via the dashboard. In other words, it is possible to restrict the presentation of the above-mentioned information.

Alternatively, if the user is a fleet manager or consultant, they may be able to view all of the information on the dashboard as described later.

Here, the user can specify their own component apparatus that he or she wants to compare with the target component apparatus via a web browser or dedicated application, or the like, from the management terminal 6.

The web server unit 130 draws the results of the comparison of the analysis information 210 for the target component apparatus set in the designation information 220 and the user-specified own component apparatus as the dashboard data 250. This makes it possible for the user to view the analysis results of his or her own component apparatus on the web browser or the dashboard in the dedicated application.

FIG. 6 shows an example of the dashboard data 250 being displayed on the management terminal 6. Here, an example is shown where the printing apparatus 2-m is selected as the own component apparatus. In this example, the target component apparatus is not displayed, but it is also possible to select this and present a comparison.

### Step S104

Then, the simulation unit 120 performs a simulation process.

The simulation unit 120 performs a simulation of the case where the same process is executed by its own component apparatus, based on the setting information 330 of the target component apparatus, which is set in the designation information 220. Specifically, the simulation unit 120 simulates what would happen to the own component apparatus when the same process as that of the target component apparatus was performed based on the analysis information 210, for any or any combination of the utilization rate, productivity, and reliability.

In the present embodiment, the simulation unit 120 simulates printing and post-processing for the specified own component apparatus based on the acquired setting information 330 of the target component apparatus.

Specifically, for example, as a simulation of utilization rate, the simulation unit 120 can simulate the processing of the past job 230 for its own component apparatus based on the acquired historical information such as the schedule setting of the past job 230 and the batch processing conditions of the target component apparatus.

As a simulation of productivity, the simulation unit 120 performs a simulation of the cost of processing. For example, the simulation unit 120 can simulate printing of past the job 230 for its own component apparatus based on the color profile included in the acquired setting information 330, and it calculate the ink cost. Alternatively, the simulation unit 120 can calculate the printing cost of past the job 230 for its own component apparatus based on cost information for ink, paper, post-processing materials, or the like, acquired from the target component apparatus. Alternatively, the simulation unit 120 can calculate the printing loss cost of past the job 230 for its own component apparatus based on information on the waste rate and paper loss rate acquired from the target component apparatus.

As a reliability simulation, the simulation unit 120 can also simulate color fluctuations, paper loss rates, and waste rates for its own component apparatus based on the maintenance schedule, color management change and setting schedule, or the like, acquired from the target component apparatus. As a result, the simulation unit 120 can analyze how much color fluctuation can be suppressed by performing maintenance and color management at what frequency and timing for its own component apparatus. As a result, it is also possible to analyze how much the paper loss rate and waste rate can be reduced, or the like.

Here, the simulation unit 120 can perform a simulation of its own component apparatus by changing the settings based on the user's instructions or by comparing with other apparatuses. In such case, the simulation unit 120 can perform a simulation in which the settings are changed for the past jobs in a specific period, such as the jobs 230 processed in the past month.

Furthermore, the simulation unit 120 calculates processing performance information about how its own component apparatus would be processed if it were processed under the conditions of the setting information 330 acquired from the target component apparatus, such as color profiles, ink restrictions, scheduling settings, batch processing conditions, or the like. More specifically, for example, the simulation unit 120 can calculate the amount of ink consumed by its own component apparatus when printing a past job 230 by using the specified color profile and ink limit, and calculate processing performance information by comparing this with the amount of ink consumed in the actual processing. Alternatively, the simulation unit 120 can simulate the processing performance information, such as whether the number of times the paper is changed can be reduced and the overall processing time can be shortened, when the past the job 230 are processed with the batch processing condition acquired from the target component apparatus.

On this basis, the simulation unit 120 is able to modify the conditions of the setting information 330 acquired from the target component apparatus to appropriate values and perform a simulation for its own component apparatus. For example, the simulation unit 120 can set only the batch processing conditions and perform a simulation to check how much the utilization rate of its own component apparatus can be improved. Furthermore, it is also possible to compare the own component apparatus with other conditions by using arbitrary setting values, or the like, acquired from other component apparatuses, which are not the target component apparatus.

Furthermore, it is also possible to perform a simulation by combining the setting values of the setting information 330 acquired from a plurality of target component apparatuses and the optimal one for the own component apparatus can be to selected based on AI, or the like.

Here, the simulation unit 120 outputs the results and effects of these simulations for the target component apparatus based on the setting information 330 of the component apparatus as the decision information 240. Specifically, the simulation unit 120 can output information indicating judgments on operational improvements and judgments on the next acquisition of the component apparatus as the decision information 240.

Thus, the web server unit 130 can present the decision information 240 on the dashboard. In this case, the utilization rate, or the like, may be determined and warnings issued by AI, or the like.

The dashboard process according to the embodiment of the present disclosure is completed.

As configured in this way, the following effects can be obtained.

In typical production printing, in order to improve the efficiency of printing operations and increase the profits of printed materials, business improvements have been made by analyzing the utilization rate, productivity, reliability, or the like, for printers.

A management system has been used to understand and analyze the status of these utilization rates, productivity, and reliability. This management system aggregates information related to printing operations, such as printer operating information and processing job information, and analyzed and displayed utilization rates, productivity, and reliability based on the aggregated information.

However, in the typical management system, it is not possible to compare important information such as utilization rates, productivity, and reliability of printing apparatuses between printers.

On the other hand, the industrial printing system X of the present embodiment is an industrial printing system for production printing, having a plurality of component apparatuses and a management server that manages the plurality of component apparatuses, the management server including:
an information acquisition unit 100 that acquires one or any combination of utilization rate information 300, productivity information 310, and reliability information 320 from the plurality of component apparatuses; an analysis unit 110 that generates analysis information 210 by comparing and analyzing the utilization rate information 300, productivity information 310, and reliability information 320 acquired by the information acquisition unit 100; and a simulation unit 120 that simulates one or any combination of utilization rate, productivity, and reliability based on the analysis information 210 generated by the analysis unit in accordance with designation information 220 that designates any one of the plurality of component apparatuses.

As configured in this way, it is possible to acquire information from the plurality of component apparatuses, which includes printing apparatuses 2 and post-processing apparatuses 3, and compare important information such as utilization rate, productivity, and reliability between component apparatuses. This can lead to improvements in the utilization rate, productivity, and reliability of component apparatuses. Further, the analysis can be used not only for analysis of the single component apparatus itself, but also for analysis comparing it with other component apparatuses. As a result, it is possible to assist in the analysis for improving efficiency and increasing profits in industrial printing.

Also, in the industrial printing system X of the present embodiment, the analysis unit 110 detects a target component apparatus with relatively high operational performance by comparing analysis information 210 between the plurality of component apparatuses and sets it to the designation information 220, and the simulation unit 120 simulates processing similar to that of the target component apparatus based on the designation information 220.

As configured in this way, it is possible to perform simulations of the utilization rate, productivity, and reliability based on the setting information 330 of the target component apparatus. In other words, it is possible to compare data not only within a single printing factory, but also between a plurality of component apparatuses within a group of companies, dealers, or manufacturers' customers, and to detect the component apparatus that is being used well as the target component apparatus. On this basis, it is possible to improve the utilization by simulating the processing of one's own component apparatus based on the setting information 330 of the target component apparatus.

Also, in the industrial printing system X of the present embodiment, the simulation unit 120 presents the simulation result related to the target component apparatus as a dashboard.

By configuring it in this way, the results of the comparison analysis can be presented to the user in an easy-to-understand manner for his or her own component apparatus. Therefore, the operation of his or her own component apparatus can be improved, and it can contribute to improving the efficiency of the entire system.

In addition, in the industrial printing system X of the present embodiment, the simulation unit 120 outputs the decision information 240 for operational improvement and acquiring the next component apparatus based on the simulation.

By configuring it in this way, it is possible to present information to the user not only for improving the operation of the own component apparatus, but also for making a judgment on investment in the next component apparatus.

Also, in the industrial printing system X of the present embodiment, the information acquisition unit 100 also acquires the setting information 330 of the plurality of component apparatuses, and the simulation unit 120 performs a simulation for the past jobs 230 in a specific period based on the setting information 330 or a case in which the setting information 330 is changed.

By configuring it in this way, it is possible to simulate how much efficiency, or the like, can actually be improved by applying the setting information 330 of the target component apparatus to the own component apparatus. Therefore, it is possible to review the configuration and improve the operation of the own component apparatus in a state closer to actual use.

### Other Embodiments

In the above-mentioned embodiment, an example that the user selects and indicates his or her own component apparatus for the simulation is described.

However, it is also possible to configure the system to detect component apparatuses with low statistical values or that are not being used well from the target component apparatus or a plurality of component apparatuses, perform simulations on these apparatuses, and notify to the user. In this case, it is also possible to only notify the user about component apparatuses that the user is contractually allowed to know about.

In the above-mentioned embodiment, it is described that the results of comparative analysis and simulation are presented as a dashboard.

However, it is also possible to present the results of comparative analysis and simulation to the user in a format such as an operational report, rather than a dashboard.

By configuring in this way, it is possible to respond to various situations. For this reason, for example, it is possible to perform comparative analysis and simulation flexibly at the required time.

Also, in the above embodiment, an example of presenting the results of comparative analysis and simulation has been described.

However, it is also possible to automatically present the user with “advice” on what kind of processing to perform based on the simulation results by using AI, statistical processing, or heuristics. For example, if reliability or productivity has fallen below a specific threshold, it may be configured to suggest replacement as the next investment.

This allows the user to receive advice and improve operations simply by watching the dashboard of the component apparatus, or the like.

Also, in the above-mentioned embodiment, the example described is of comparative analysis and simulation of the printing apparatus 2 and the post-processing apparatus 3 as component apparatuses.

However, comparative analysis and simulation of other component apparatuses or comparative analysis and simulation of different types of component apparatuses may be performed together.

By configuring in this way, comparative analysis and simulation can be performed flexibly according to the type and number of component apparatuses, and the results can be summarized as a system.

Also, in the above-mentioned embodiment, the example described is one in which comparison analysis and simulation are performed on a management server.

However, it is also possible to configure a system in which comparison analysis and simulation are performed by communicating between component apparatuses in a peer-to-peer manner. In this case, it is also possible to present a warning to the user via a display, or the like, provided on the component apparatus with low statistical performance.

In the terminology used in this specification, the singular forms “a”, “an” and “the” also include the plural forms, unless the context clearly indicates otherwise.

Furthermore, it goes without saying that the configurations and operations of the above-described embodiments are merely examples and can be modified as appropriate without departing from the spirit and scope of the present disclosure.

What is claimed is:

1. An industrial printing system for production printing, having a plurality of component apparatuses and a management server that manages the plurality of component apparatuses, the management server comprising:
an information acquisition unit configured to acquire one or any combination of utilization rate information, productivity information, and reliability information from the plurality of component apparatuses;
an analysis unit configured to generate analysis information by comparing and analyzing the utilization rate information, productivity information, and reliability information acquired by the information acquisition unit; and
a simulation unit configured to simulate one or any combination of utilization rate, productivity, and reliability based on the analysis information generated by the analysis unit in accordance with designation information that designates any one of the plurality of component apparatuses.

2. The industrial printing system according to claim 1, wherein
the analysis unit detects a target component apparatus with relatively high operational performance by comparing the analysis information between the plurality of component apparatuses and sets to the designation information, and
the simulation unit simulates processing similar to that of the target component apparatus from the designation information.

3. The industrial printing system according to claim 2, wherein
the simulation unit presents simulation result of the target component apparatus as a dashboard.

4. The industrial printing system according to claim 1, wherein
the simulation unit outputs decision information for operational improvement and the acquisition of the next component apparatus based on the simulation.

5. The industrial printing system according to claim 1, wherein
the information acquisition unit also acquires setting information of the plurality of component apparatuses, and
the simulation unit performs a simulation for past jobs in a specific period based on the setting information or a case in which the setting information is changed.

6. A management server that manages a plurality of component apparatuses in an industrial printing system that performs production printing, comprising:
an information acquisition unit configured to acquire one or any combination of utilization rate information, productivity information, and reliability information from the plurality of component apparatuses;
an analysis unit configured to generate analysis information by comparing and analyzing the utilization rate information, productivity information, and reliability information acquired by the information acquisition unit; and
a simulation unit configured to simulate one or any combination of utilization rate, productivity, and reliability based on the analysis information generated by the analysis unit in accordance with designation information that designates one of the plurality of component apparatuses.

7. The management server according to claim 6, wherein
the analysis unit detects a target component apparatus with relatively high operational performance by comparing the analysis information between the plurality of component apparatuses and sets to the designation information, and
the simulation unit simulates processing similar to that of the target component apparatus from the designation information.

8. The management server according to claim 7, wherein
the simulation unit presents simulation result of the target component apparatus as a dashboard.

9. The management server according to claim 6, wherein
the simulation unit outputs decision information for operational improvement and the acquisition of the next component apparatus based on the simulation.

10. The management server according to claim 6, wherein
the information acquisition unit also acquires setting information of the plurality of component apparatuses, and
the simulation unit performs a simulation for past jobs in a specific period based on the setting information or a case in which the setting information is changed.

11. A management method for managing a plurality of component apparatuses by an industrial printing system that performs production printing, comprising the steps of:
acquiring from the plurality of component apparatuses one or any combination of utilization rate information, productivity information, and reliability information;
generating analysis information by comparing and analyzing the acquired utilization rate information, productivity information, and reliability information; and
simulating one or any combination of utilization rate, productivity, and reliability based on the generated analysis information in accordance with the designation information that designates any one of the plurality of component apparatuses.

12. The management method according to claim 11, further comprising steps of:
detecting a target component apparatus with relatively high operational performance by comparing the analysis information between the plurality of component apparatuses;
setting the target component apparatus to the designation information, and
simulating processing similar to that of the target component apparatus from the designation information.

13. The management method according to claim 12, further comprising a step of:
presenting simulation result of the target component apparatus as a dashboard.

14. The management method according to claim 11, further comprising a step of:
outputting decision information for operational improvement and the acquisition of the next component apparatus based on the simulation.

15. The management method according to claim 11, further comprising a step of:
acquiring setting information of the plurality of component apparatuses, and
performing a simulation for past jobs in a specific period based on the setting information or a case in which the setting information is changed.
